(19) United States
(12) Patent Application Publication
(10) Pub. No.: US 2018/0025522 A1
(43) Pub. Date: Jan. 25, 2018

(54) DISPLAYING LOCATION-SPECIFIC CONTENT VIA A HEAD-MOUNTED DISPLAY DEVICE

(71) Applicant: Deutsche Telekom AG, Bonn (DE)

(72) Inventor: Wolfgang Wirths, Bonn (DE)

(21) Appl. No.: 15/652,253

(22) Filed: Jul. 18, 2017

(30) Foreign Application Priority Data
Jul. 20, 2016 (EP) 16180442.2

(51) Int. Cl. G06T 11/60; H04W 4/06

(52) U.S. Cl. CPC G06T 11/60; H04W 4/06; G02B 27/017

(57) ABSTRACT

A method for displaying location-specific content via a head-mounted display device includes: receiving, by the head-mounted display device, the location-specific content, wherein the location-specific content is related to a predetermined spatial position; determining, by the head-mounted display device, a distance between the head-mounted display device and the predetermined spatial position; and displaying, by the head-mounted display device, the location-specific content based on the determined distance between the head-mounted display device and the predetermined spatial position.

### CROSS-REFERENCE TO RELATED APPLICATIONS

Priority is claimed to European Patent Application No. EP16180442.2, filed on Jul. 20, 2016, the entire disclosure of which is hereby incorporated by reference herein.

### FIELD

The present invention relates to a method for displaying location-specific content by a head-mounted display device.

Furthermore, the present invention relates to a system for displaying location-specific content by a head-mounted display device.

### BACKGROUND

There is a growing need for technologies that provide information to users in order to assist them in everyday life or in professional applications. In augmented reality systems a real scene can be perceived that is enriched by virtual elements. For example, the real scene may be enriched by a text panel or a pictogram. In such systems head-mounted displays (HMDs) are often employed for displaying virtual information content. However, aligning those virtual elements with the real world is challenging. Thus, there is a need for technologies to improve embedding virtual elements in the real-world view.

### SUMMARY

In an exemplary embodiment, the invention provides a method for displaying location-specific content via a head-mounted display device. The method includes: receiving, by the head-mounted display device, the location-specific content, wherein the location-specific content is related to a predetermined spatial position; determining, by the head-mounted display device, a distance between the head-mounted display device and the predetermined spatial position; and displaying, by the head-mounted display device, the location-specific content based on the determined distance between the head-mounted display device and the predetermined spatial position.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a system according to the present invention.

### DETAILED DESCRIPTION

Exemplary embodiments of the present invention provide for a more realistic integration of location-specific content in the real-world view of a head-mounted display device.

In an exemplary embodiment, the present invention provides a method for displaying location-specific content by a head-mounted display device, comprising:
in a first step, transmitting location-specific content, the location-specific content being related to a predetermined spatial position,
in a second step, subsequent to the first step, receiving the location-specific content by a head-mounted display device,
in a third step, determining a distance between the head-mounted display device and the predetermined spatial position,
in a fourth step, subsequent to the third step, displaying the location-specific content using the head-mounted display device depending on the determined distance between the head-mounted display device and the predetermined spatial position.

According to the present invention location-specific content is related to a predetermined spatial position, e.g., a position of a building or a landmark. The location-specific content is received by a head-mounted display device. The distance between the head-mounted display device and the predetermined spatial position is determined so as to allow for scaling and rendering the location-specific content. Thereby an improved degree of immersion may be provided when displaying the location-specific content in the head-mounted display. Subsequent to determining the distance between the head-mounted display device and the predetermined spatial position the location-specific content is displayed using the head-mounted display device depending on the determined distance. Thus, the invention provides an improved method of providing location-specific content to a mobile user by way of augmented reality technology.

Within the context of the presented invention, a head-mounted display device is considered as a display device that is configured to be worn on the head of a user, e.g., in form of eyeglasses or as part of a helmet. The head-mounted display device may be an optical head-mounted display device which comprises a semi-transparent display screen on which the location-specific content is projected onto. Those head-mounted display devices are often referred to as of the optical see-through type. Alternatively, the head-mounted display device may display a real-world view provided by a video camera which is overlaid by the location-specific content. Combining of the real-world view and the location-specific content may be done electronically. Such head-mounted display devices are typically referred to as of the video see-through type. Further alternatively, the head-mounted display device may be virtual retinal display device which projects a display on the retina of the eye of the user.

The location-specific content is related to the predetermined spatial position. In case the predetermined spatial position is a position of a shop the location-specific content may include information related to the shop, e.g., opening hours of the shop or special offers for products sold in the shop. If the predetermined spatial position is a position of a landmark the location-specific content may include tourist information concerning the landmark or opening hours of the landmark. In case the predetermined spatial position is a position of a parking ground or parking deck the location-specific content may include a price table or a display of free parking positions.

The location-specific content may be interactive content. An example of such an interactive content is a user interface of a software application which provides functionality relating to the predetermined spatial position. The interactive content may be in the form of a user interface for processing payment transactions, in particular cashless payments. E.g., the interactive content may provide a payment service for a shop, a landmark or a parking ground.

The location-specific content may additionally be time specific. In other words, location-specific content may change over time or may only be available for a predetermined period. Preferably, in the first step, location-specific content is transmitted, the location-specific content being related to a predetermined spatial position and a predetermined period. The content may only be sent during the predetermined period.

According to a preferred embodiment of the present invention, a viewing surface, in particular a facade of a building, is located at the predetermined spatial position and, in the fourth step, the location-specific content is displayed as an overlay to the viewing surface.

According to the present invention, it is thereby advantageously possible to provide location-specific content to a user wearing the head-mounted display device, wherein the content is visible at a viewing surface that is situated at the predetermined position in the real world. Advantageously, the location-specific content is displayed as a transparent or semi-transparent overlay to the viewing surface, so that characteristics of the real-world viewing surface are at least partly visible to the user of the head-mounted display. Alternatively, the overlay may be opaque. Preferably, it is determined if the viewing surface is visible from the position of the head-mounted display device. In other words a missing line of sight between the head-mounted display device and the viewing surface may be detected. Display of the location-specific content may be adapted accordingly. E.g., the location-specific content may be displayed using dotted lines.

According to a preferred embodiment of the present invention, the method further comprises:
in a first intermediate step, subsequent to the first step and prior to the second step, receiving the location-specific content by a mobile user device, in particular a cell phone,
in a second intermediate step, subsequent to the first intermediate step and prior to the second step, transmitting the location-specific content from the mobile user device to the head-mounted display device, the head-mounted display device being separate from the mobile user device.

According to the present invention, it is thereby advantageously possible to reduce complexity of the head-mounted display device. Hardware resources for receiving the transmitted location-specific content may be arranged in the mobile user device. Those hardware resources may be configured as long distance wireless communication resources, e.g., as a cell phone or a satellite phone. The head-mounted display device may include hardware resources for short distance wireless communication, e.g., a Bluetooth receiver, a ZigBee receiver or a Wi-Fi receiver.

According to a preferred embodiment of the present invention, in the third step, the distance between the head-mounted display device and the predetermined spatial position is determined using a measurement device of the head-mounted display device, in particular an optical measurement device; and/or in the third step, the distance between the head-mounted display device and the predetermined spatial position is determined using distance information received by a mobile user device, in particular a cell phone, from a base station of a mobile communication network.

According to the present invention, it is thereby advantageously possible to reliably determine the distance between the head-mounted display and the predetermined spatial position, in particular a viewing surface located at the predetermined spatial position. The measurement device may be an optical measurement device, e.g., a laser rangefinder. The determined distance may be transmitted from the head-mounted display device to the mobile user device for further processing. Alternatively or additionally, the distance is determined using a separate mobile user device, e.g., a cell phone. As the mobile user device is typically in close proximity to the head-mounted display device, it is typically carried by the user of the head-mounted display device, the distance between the head-mounted display device and the predetermined spatial position can be approximated by the distance between the mobile user device and the predetermined spatial position. The mobile communication network may determine the position of the mobile user device. The position of the mobile user device may be continuously tracked by the mobile communication network. The position of the mobile user device may be transmitted from base stations of the mobile communication network to the mobile user device continuously. Alternatively, the position of the mobile user device can be determined using a satellite navigation system, e.g., the Global Positioning System (GPS). According to another alternative, the position of the mobile user device may be determined by a sensor of the mobile user device, e.g., a video camera or an infrared sensor. Based on the position of the mobile user device, which approximately equals the position of the head-mounted display device, the distance between the head-mounted display device and the predetermined spatial position can be calculated and transmitted to the mobile user device.

According to a preferred embodiment of the present invention, in the first step, location-specific content is transmitted via a cell broadcast from a base station of a mobile communication network to a plurality of mobile user devices, in particular cell phones. Thus, location-specific content is transmitted as a broadcast message. The broadcast message may reach a huge number of users at once, thereby reducing the required transmission bandwidth.

According to the present invention, it is thereby advantageously possible to transmit the local specific content to a plurality of mobile user devices of a mobile communication network, in particular a Global System for Mobile communication (GSM) or Universal Mobile Telecommunications Service (UMTS) network. A further benefit of distributing the content via a cell broadcast is that transmission of the content is not affected by high network load. Thus, location-specific content can be provided to the user even during high network load situations. The information to be broadcasted may be common information, e.g., opening hours of a shopping mall.

According to a preferred embodiment of the present invention, in the third step, the spatial position of the head-mounted display is determined; and wherein, in the fourth step, the location-specific content is displayed using the head-mounted display device additionally depending on the determined spatial position of the head-mounted display device.

According to the present invention, it is thereby advantageously possible to selectively display the location-specific content depending on the spatial position of the head-mounted display device. Preferably, the location-specific content is only displayed if the determined distance is below a given maximum distance value and the predetermined spatial position, e.g., where the shop is located at, is visible from the spatial position of the head-mounted display device.

According to a preferred embodiment of the present invention, in the third step, the eye movement and/or a viewing angle of a user of the head-mounted display device is determined; and wherein, in the fourth step, the location-specific content is displayed using the head-mounted display device additionally depending on the determined eye movement and/or a determined viewing angle.

According to the present invention, it is thereby advantageously possible to improve perspective view of the content. Using determined eye movement and/or a determined viewing angle the location-specific content may be displayed using the head-mounted display device with a correct perspective. The eye movement can be determined by an eye tracking device of the head-mounted display device. The viewing angle can be determined by an inertial navigation system (INS) attached to the head-mounted display device.

According to a preferred embodiment of the present invention, in a third intermediate step, subsequent to the third step and prior to the fourth step, location-specific content to be displayed is rendered using a mobile user device, in particular a cell phone, the mobile user device being separate from the head-mounted display device.

According to the present invention, it is thereby advantageously possible to reduce computing resources of the head-mounted display device. Processing of the location-specific content to be displayed, e.g. scaling and rendering of the content, is done using a processor of the mobile user device. Then, rendered location-specific content is transmitted to the head-mounted display device.

According to an alternative preferred embodiment of the present invention, in a third intermediate step, subsequent to the third step and prior to the fourth step, location-specific content to be displayed is rendered using a processor of a mobile communication network.

According to the present invention, it is thereby advantageously possible to transfer computationally intensive tasks to a powerful processing resource external to the head-mounted display or a mobile user device connected with the head-mounted display. Consequently, latency may be reduced in order to provide seamless experience to the user of the head-mounted display device.

According to a preferred embodiment of the present invention, the mobile user device is identified by the mobile communication network, in particular a server of the mobile communication network. Alternatively or additionally to broadcasted location-specific content, personal location-specific content is transmitted from the mobile communication network, in particular from the server of the mobile communication network, to the mobile user device. The mobile communication network may keep a continuous connection to the mobile user device. In case the mobile user device is detected to be in the proximity of the predetermined spatial position, personal location-specific content may be transmitted to the mobile user device via the mobile communications network. The personal location-specific content may then be scaled and/or rendered by the mobile user device and forwarded to the head-mounted display device for displaying it as an overlay to the real-world view.

According to the present invention, it is thereby advantageously possible to provide personalized content to the user of the head-mounted display device. The personal content may be transmitted to the head-mounted display via a dedicated network resource, e.g., a dedicated channel. The dedicated network resource my comprise personalization intelligence in the backend, e.g., a virtual private assistant.

According to a preferred embodiment of the present invention, in the fourth step, the location-specific content is displayed in a transparent or semi-transparent display of the head-mounted display device; or the location-specific content is displayed in a non-transparent display of a head-mounted display device.

According to a preferred embodiment of the present invention, display of the location-specific content is controlled by a wearable device, in particular a ring, a wristband or a watch.

According to the present invention, it is thereby advantageously possible to interpret gestures of the user of the head-mounted display device in order to control the display of location-specific content. By way of the wearable device it is possible to navigate through the content displayed in the head-mounted display device, e.g., by scrolling the content and/or selecting pieces of content.

The present invention also relates to a system for displaying location-specific content by a head-mounted display device, comprising:
a transmitter for transmitting location-specific content, the location-specific content being related to a predetermined spatial position,
a head-mounted display device for receiving the location-specific content,
a distance measurement device for determining a distance between the head-mounted display device and the predetermined spatial position, and
a display head-mounted display device for displaying the location-specific content depending on the determined distance between the head-mounted display device and the predetermined spatial position.

With the system according to the invention the same advantages can be achieved as described above in relation to the method according to the invention.

Furthermore, the present invention relates to a program comprising a computer-readable program code which, when executed on a head-mounted display device or on a mobile user device or on a base station, or in part on the head-mounted display device and in part on the mobile user device and in part on the base station, causes the head-mounted display device and/or the mobile user device and/or the base station to perform a method according to the present invention.

Furthermore, the present invention relates to a computer program product for using a head-mounted display device with a base station, the computer program product comprising a computer program stored on a storage medium, the computer program comprising program code which, when executed on a head-mounted display device or on a mobile user device or on a base station, or in part on the head-mounted display device and in part on the mobile user device and in part on the base station, causes the head-mounted display device and/or the mobile user device and/or the base station to perform a method according to the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to an particular embodiment and with reference to a drawing but the invention is not limited thereto but only by the claims. The drawing described is only schematic and is non-limiting. In the drawing, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

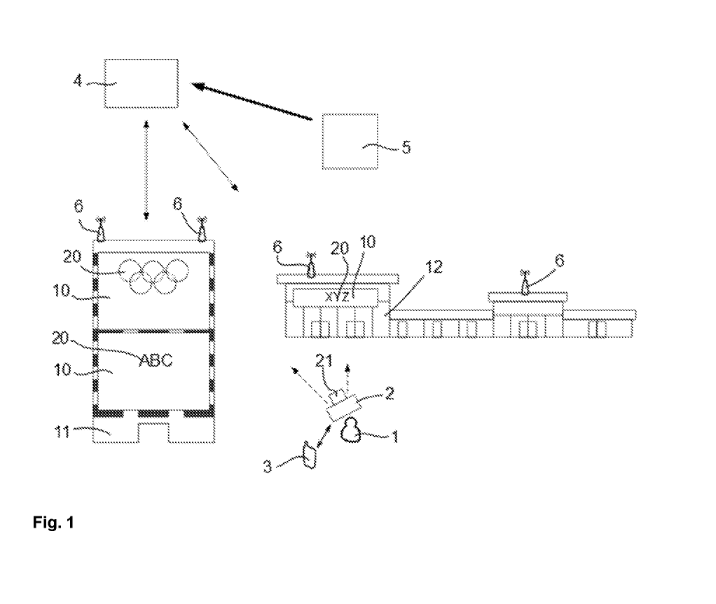

In FIG. 1, a system for displaying location-specific content related to a predetermined spatial location by a head-mounted display device according to an embodiment of the present invention is illustrated. The system according to the exemplary embodiment uses a mobile communication network for transmitting location-specific content to the head-mounted display device 2. However, the skilled person may contemplate alternative communication technologies, e.g., a satellite communication network.

The system comprises a plurality of transmitters 6 in the form of base stations of the mobile communication network. Those transmitters 6 are configured to transmit location-specific content provided by a server 4, 5 of the mobile communication network to a mobile user device 3, e.g., a cell phone. The mobile user device 3 is carried by a user 1 and is connected to a head-mounted display device 2 worn by the same user 1 by a wireless connection, e.g., by a Bluetooth connection, a Wi-Fi connection or a ZigBee connection.

The head-mounted display device 2 comprises a display which is either of the transparent or semi-transparent type (optical see-through) or of the non-transparent type (video see-through). The head-mounted display device further comprises a distance measurement device 21 which is configured to determine a distance between the head-mounted display device 2 and a predetermined spatial position, e.g., a facade of a building 11, 12. The distance measurement device 21 is configured as an optical distance measurement device, e.g., a laser rangefinder. Alternatively or additionally, the distance is determined using the mobile user device 3, e.g. a cell phone. The mobile communication network determines the distance between the mobile user device 3 and the predetermined spatial position and transmits the distance to the mobile user device, in particular via a dedicated communication channel. As will be described in detail in the following the head-mounted display device 2 is displaying the location-specific content depending on the determined distance between the head-mounted display device 2 and the predetermined spatial position.

The location-specific content is related to a predetermined spatial position. In the exemplary embodiment a first predetermined spatial position is a position of a viewing surface 10 configured as a facade of a mixed business building 11 that includes several shops and/or offices. A second predetermined spatial position is a position of a viewing surface 10 configured as a facade of a mall 12 comprising a plurality of shops. The method and system according to the invention allow for providing an realistic overlay of the location-specific content 20 to the facade of the building 11 and/or the mall 12. Using exemplary embodiments of the inventive method and system, the location-specific content 20 can be displayed in correct perspective.

In a first step, location-specific content is transmitted by a server 4, 5 of the mobile communication network via a base station 6 to the mobile user device 3. In a first intermediate step, subsequent to the first step and prior to the second step, the location-specific content is received by the mobile user device 3. In a second intermediate step, subsequent to the first intermediate step and prior to the second step, the location-specific content is transmitted from the mobile user device 3 to the head-mounted display device 2. Communication between the mobile user device 3 and the head-mounted display device 2 may be enabled by a short-distance wireless connection, e.g. a Bluetooth connection, a Wi-Fi connection or a ZigBee connection.

In a second step, subsequent to the first step, the location-specific content is received by the head-mounted display device 2.

In a third step, the distance between the head-mounted display device 2 and the predetermined spatial position is determined using the measurement device 21 of the head-mounted display device 2 and/or the distance between the head-mounted display device 2 and the predetermined spatial position is determined using distance information received by the mobile user device 3 from a base station 6 of the mobile communication network. Further, in the third step, the eye movement and a viewing angle of a user of the head-mounted display device 2 is determined. The eye movement is determined by an eye tracking device of the head-mounted display device 2. The viewing angle can be determined by an inertial navigation system (INS) of the head-mounted display device 2.

The determined distance, the determined eye movement and the determined viewing angle are provided to the mobile user device 3 for processing of the location-specific content received. A processor of the mobile user device 3 renders the location-specific content in order to provide a display of the content 20 in correct perspective. Using the processor of the mobile user device 3 the content can be processed in real time The rendered content is transmitted from the mobile user device 3 to the head-mounted display device 2 and, in the fourth step, the location-specific content 20 is displayed using the head-mounted display device 2 depending on the determined distance, the determined eye movement and the determined viewing angle. In the exemplary embodiment depicted in FIG. 1 the displayed location-specific content 20 is in the form of an advertisement that is embedded in the real-world view on viewing surface 10 of a building 11, 12.

The location-specific content may be transmitted via a cell broadcast from a base station 6 of a mobile communication network to a plurality of mobile user devices 3 in form of a broadcast message. The broadcast message may reach a huge number of mobile user devices 3 at once, thereby reducing the required transmission bandwidth in the mobile communication network.

Alternatively, the location-specific content may be transmitted via individual messages directed to a single mobile user device 3. First of all, the mobile user device 3 is identified by the mobile communication network, in particular a server 4, 5 of the mobile communication network. Thus, a user of both the mobile user device 3 and the head-mounted display device 2 may be identified. In the event that the head-mounted display device 2 is in the vicinity of the predetermined spatial location transmission of location-specific content, e.g., a stream of virtual reality data, may be triggered to be sent from a server 4, 5 of the mobile communication network via a base station 6 to the mobile user device 3.

The mobile communication network comprises at least one network provider server 4 hosted by the provider of the mobile communication network and at least one third party server 5 hosted by a third party. According to an alternate embodiment of the invention, the network provider server 4 continuously tracks the spatial position of the mobile user device 3. If the network provider server 4 detects that the mobile user device 3 is located in the vicinity of a first predetermined spatial position, the network provider server 4 authenticates on behalf of the user to the third party server 5 which hosts content related to the first predetermined spatial position. Thereby, the third party server 5 is triggered to transmit location-specific content related to the first predetermined position via the mobile communication network to the mobile user device 3 and, to the head-mounted display 2, respectively.

The displayed content 20 may be passive content which is to be displayed for the purpose of providing information to the user of the head-mounted display device 2. Alternatively, interactive content 20 may be displayed using the head-mounted display device. The interactive content 20 may be in the form of a user interface for processing payment transactions, in particular cashless payments. The head-mounted display device 2 may display an interface that allows authorizing such a payment. A two-factor authentication can be used, wherein a keypad is displayed using the head-mounted display device 2. The user enters a predetermined PIN via a gesture tracking device of the head-mounted display device. In case the PIN is entered correctly, a scan of the iris of the user of the head-mounted display device is triggered. Thereby, the user may authorize payments and/or transaction in interaction with the head-mounted display device 2 and/or the mobile user device 3.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for displaying location-specific content via a head-mounted display device, comprising:
receiving, by the head-mounted display device, the location-specific content, wherein the location-specific content is related to a predetermined spatial position;
determining, by the head-mounted display device, a distance between the head-mounted display device and the predetermined spatial position; and
displaying, by the head-mounted display device, the location-specific content based on the determined distance between the head-mounted display device and the predetermined spatial position.

2. The method according to claim 1, wherein a viewing surface is located at the predetermined spatial position and the location-specific content is displayed as an overlay to the viewing surface.

3. The method according to claim 1, wherein the location-specific content is received by the head-mounted display device from a mobile user device.

4. The method according to claim 1, wherein determining the distance between the head-mounted display device and the predetermined spatial position is performed using an optical measurement device.

5. The method according to claim 1, wherein determining the distance between the head-mounted display device and the predetermined spatial position comprises receiving distance information from a mobile user device.

6. The method according to claim 1, wherein the location-specific content is transmitted via a cell broadcast from a base station of a mobile communication network to a plurality of mobile user devices.

7. The method according to claim 1, further comprising:
determining a spatial position of the head-mounted display; and
wherein displaying the location-specific content is further based on the determined spatial position of the head-mounted display device.

8. The method according to claim 1, further comprising:
determining eye movement and/or a viewing angle of a user of the head-mounted display device; and
wherein displaying the location-specific content is further based on the determined eye movement and/or the determined viewing angle.

9. The method according to claim 1, wherein the location-specific content to be displayed is rendered using a mobile user device prior to being displayed.

10. The method according to claim 9, wherein the mobile user device is identified by a server of a mobile communication network.

11. The method according to claim 1, wherein the location-specific content is displayed on a transparent or semi-transparent display of the head-mounted display device.

12. The method according to claim 1, wherein the location-specific content is displayed on a non-transparent display of the head-mounted display device.

13. The method according to claim 1, wherein display of the location-specific content is controlled by a wearable device.

14. A system for displaying location-specific content, comprising:
a head-mounted display device, configured to receive the location-specific content, wherein the location-specific content is related to a predetermined spatial location; and
a distance measurement device, configured to determine a distance between the head-mounted display device and the predetermined spatial position;
wherein the head-mounted display device is further configured to display, via a display of the head-mounted display device, the location-specific content based on the determined distance between the head-mounted display device and the predetermined spatial position.

15. A non-transitory computer-readable medium having processor-executable instructions stored thereon for displaying location-specific content via a head-mounted display device, the processor-executable instructions, when executed, facilitating performance of the following:
receiving the location-specific content, wherein the location-specific content is related to a predetermined spatial position;
determining a distance between the head-mounted display device and the predetermined spatial position; and
displaying the location-specific content based on the determined distance between the head-mounted display device and the predetermined spatial position.
